(19) United States
(12) Patent Application Publication
(10) Pub. No.: US 2014/0200919 A1
(43) Pub. Date: Jul. 17, 2014

(54) METHOD AND APPARATUS FOR PERMITTING PATIENT DEFINITION OF CONSENT AND SHARING RULES

(71) Applicant: MCKESSON FINANCIAL HOLDINGS, Hamilton (BM)

(72) Inventor: Arien Malec, Oakland, CA (US)

(73) Assignee: Mckesson Financial Holdings, Hamilton (BM)

(21) Appl. No.: 13/852,745

(22) Filed: Mar. 28, 2013

Related U.S. Application Data
(60) Provisional application No. 61/751,616, filed on Jan. 11, 2013.

(51) Int. Cl. G06Q 50/24; G06Q 10/00

(52) U.S. Cl. CPC G06Q 50/24; G06Q 10/00
USPC 705/3

(57) ABSTRACT

A method, apparatus and computer program product are provided to permit a patient to provide their preferences with respect to the consent required for and the rules that would govern any sharing of health information. In the context of a method, a patient is permitted to view a central patient identifier, one or more data locations at which health information of the patient is stored and respective local patient identifiers associated with the one or more data locations. The method also receives input from the patient regarding the patient's preferences with respect to consent for sharing of the health information or with respect to one or more rules that govern the sharing of the health information. Further, the method translates the patient's preferences based upon technology utilized by the one or more data locations to implement the patient's preferences at each of the one or more data locations.

### CROSS-REFERENCE TO A RELATED APPLICATION

This application claims the benefit of U.S. Provisional Application No. 61/751,616, filed Jan. 11, 2013, which is incorporated by reference herein in its entirety.

### TECHNOLOGICAL FIELD

An example embodiment of the present invention relates generally to the controlled sharing of health information between entities and, more particularly, to permitting patients to define consent and sharing rules that govern the manner in which the health information of the patient will be shared.

### BACKGROUND

Health information exchanges have been established in order to control the sharing of health information between various entities, such as between hospitals, pharmacies, physicians, radiologists, other types of healthcare practices and the like. Although the care that may be provided for a patient by the various entities may be facilitated by the sharing of the patient's health information, the sharing of health information is generally limited for a variety of reasons including legal requirements and the privacy interests of the patients.

In this regard, patient consent is frequently required prior to sharing a patient's health information, thereby providing some control and participation by the patient in conjunction with the sharing of their health information. However, health information exchanges generally apply the same consent requirements for all entities that are serviced by the health information exchange. Thus, the consent provided by a patient in regards to the sharing of the patient's health information and any rules defined by the patient that may dictate the manner in which the patient's health information may be shared may be applied universally by a health information exchange to all of the entities serviced by the health information exchange. This universal application of the consent provided by a patient and any rules defined by the patient may be disadvantageous in that the patient's health information may be stored by a number of different entities and the patient may now want the health information stored by the various entities shared in the same manner.

As a result of the universal application of the consent provided by a patient and any rules defined by the patient, a patient may provide consent and relatively liberal rules in regards to the sharing of their health information, which may be suitable for some of the entities that are serviced by the health information exchange, but which may permit greater sharing of the health information by other entities than is desired by the patient. Alternatively, the patient may provide consent and relatively strict rules in regards to the sharing of their health information, which may be suitable for some of the entities that are serviced by the health information exchange, but which may undesirably limit the sharing of the health information by other entities than is desired by the patient. In either scenario, the universal application of the consent provided by a patient and any rules defined by the patient may result in the patient's health information being shared, at least by some entities serviced by a health information exchange, in a manner that is misaligned with the patient's desires.

### BRIEF SUMMARY

A method, apparatus and computer program product are provided in accordance with one embodiment to permit a patient to provide their preferences with respect to the consent required for sharing of health information of the patient and the rules that would govern any sharing of the health information of the patient. As such, the patient can be more involved in and, indeed, can direct the manner in which the health information of the patient is shared. In instances in which the health information of the patient is stored in a plurality of data locations, however, the method, apparatus and computer program product of one embodiment may translate the patient's preferences based upon the technology employed by the various data locations, thereby effecting the patient's preferences without requiring the patient to individually define the consent required for sharing of health information of the patient and the rules that would govern any sharing of the health information of the patient for each of the various data locations.

In one embodiment, a method is provided that includes permitting a patient to view a central patient identifier, one or more data locations at which health information of the patient is stored and respective local patient identifiers associated with the one or more data locations. The method also receives input from the patient regarding the patient's preferences with respect to consent for sharing of the health information of the patient or with respect to one or more rules that govern the sharing of the health information of the patient. Further, the method translates, with processing circuitry, the patient's preferences based upon technology utilized by the one or more data locations to implement the patient's preferences at each of the one or more data locations. In one embodiment, the translation of the patient's preferences includes differently translating the patient's preferences for one data location than for another data location based upon the technology utilized by the data locations. In another embodiment, an apparatus comprising processing circuitry configured to perform comparable functionality is provided. In a further embodiment, a computer program product including at least one non-transitory computer-readable storage medium having computer-executable program code instructions stored therein that include program code instructions configured to perform comparable functionality is also provided.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a system including a plurality of entities between which health information may be shared in accordance with an example embodiment of the present invention;

FIG. 2 is a block diagram of an apparatus that may be specifically configured in accordance with an example embodiment of the present invention; and

FIG. 3 is a flow chart illustrating the operations performed, such as by the apparatus of FIG. 2, in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A patient's health information may be stored by at one or more data locations, each of which may be associated with a respective health care practice. The patient's health information may be associated with an identifier that uniquely identifies the patient. In this regard, a patient may be identified by a central patient identifier that universally identifies the patient for each of the one or more data locations. Additionally, the patient may be identified by one or more local patient identifiers, each of which is associated with and identifies the patient for a respective data location. Although the one or more data locations that store the patient's health information may be serviced by different health information exchanges (HIEs) or may not be serviced by an HIE at all, the method, apparatus and computer program product of one embodiment in which the one or more data locations are serviced by a single HIE will be described below for purposes of example, but not of limitation.

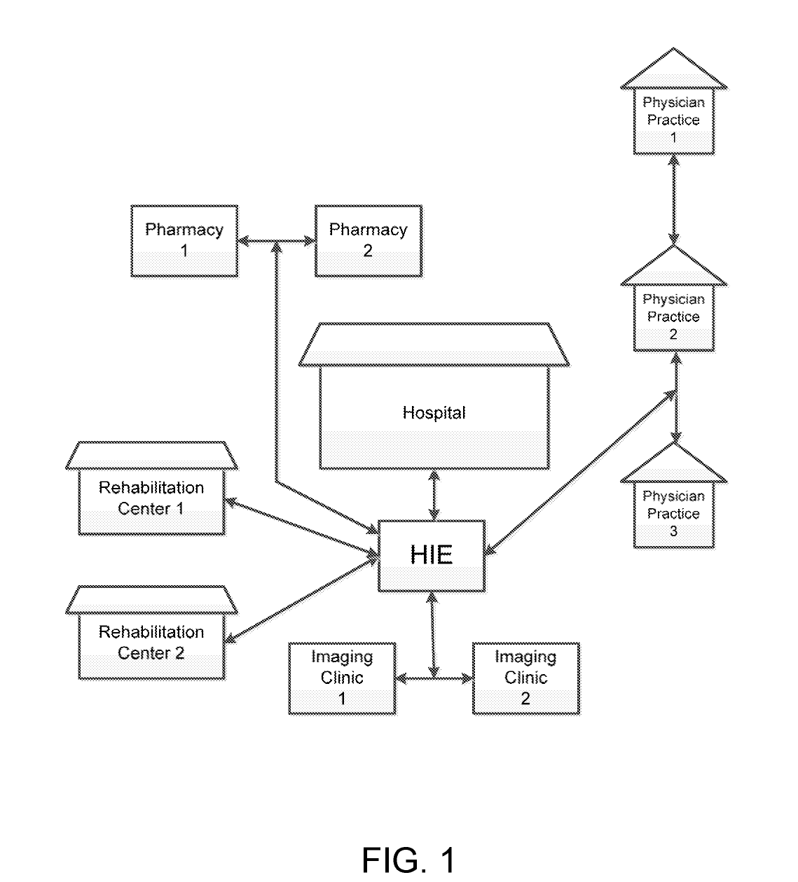

Referring now FIG. 1, an HIE as well as a plurality of entities serviced by the health information exchange are depicted. The plurality of entities may include any entity that creates, collects, maintains, accesses or otherwise uses or shares health information. As such, each entity may represent a respective data location. FIG. 1 illustrates several examples of entities serviced by the health information exchange, but a health information exchange may service additional or different types of entities in other embodiments. Thus, the entities depicted in FIG. 1 are shown by way of example, but not of limitation. In any event, the health information exchange of FIG. 1 is in communication with a hospital, a plurality of physician practices, a plurality of imaging clinics, a rehabilitation center and a plurality of pharmacies.

The health information exchange may be embodied by a computing device, such as a server or the like. Although the health information exchange is shown in FIG. 1 to be separate from and in communication with the various entities, the health information exchange may be co-located with one or more of the entities in other embodiments. Additionally, while a single health information exchange is depicted in the embodiment of FIG. 1, the health information exchange may be decentralized and, in one embodiment, a plurality of entities may include a portion of the health information exchange functionality.

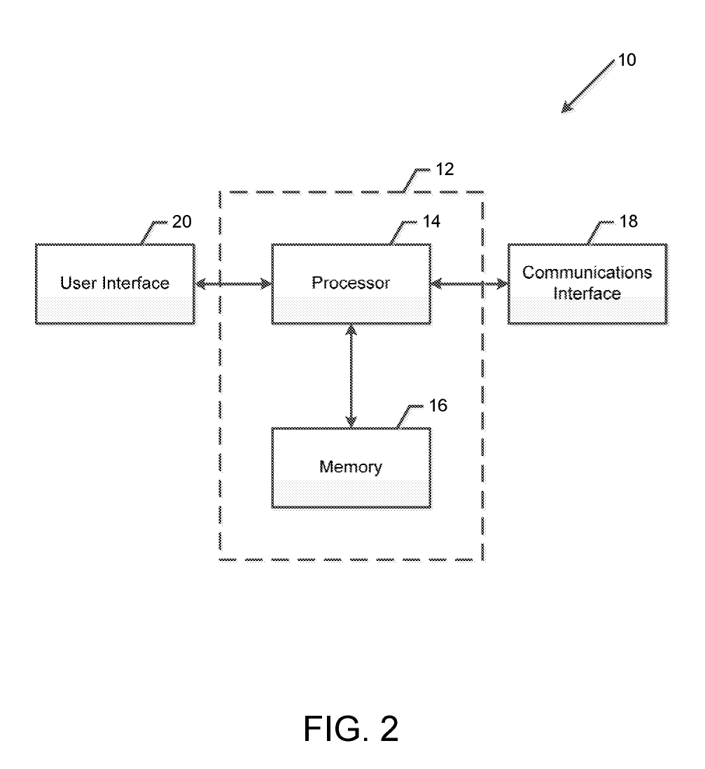

One example of a computing device 10 that may be specifically configured to perform a sequence of operations in accordance with an example embodiment of the present invention is depicted in FIG. 2 and described below. The computing device of FIG. 2 may be the same computing device that embodies the health information exchange or a different computing device that is in communication with the computing device that embodies the health information exchange. However, it should be noted that some embodiments may include further or different components, devices or elements beyond those shown and described herein.

As shown in FIG. 2, the computing device 10 may include or otherwise be in communication with a processing system including, for example, processing circuitry 12 that is configurable to perform actions in accordance with example embodiments described herein. The processing circuitry may be configured to perform data processing, application execution and/or other processing and management services. The processing circuitry may include a processor 14 and memory 16 that may be in communication with or otherwise control a communication interface 18 and a user interface 20.

The communication interface 18 may include one or more interface mechanisms for enabling communication with the other entities. In this regard, the communication interface may include, for example, an antenna (or multiple antennas) and supporting hardware and/or software for enabling the communications with the data locations that store the patient's health information, such as with the entities serviced by a health information exchange in the embodiment of FIG. 1.

In an example embodiment, the memory 16 may include one or more non-transitory memory devices such as, for example, volatile and/or non-volatile memory that may be either fixed or removable. The memory may be configured to store information, data, applications, instructions or the like for enabling the computing device 10 to carry out various functions in accordance with example embodiments of the present invention. For example, the memory could be configured to buffer input data for processing by the processor 14. Additionally or alternatively, the memory could be configured to store instructions for execution by the processor.

The processor 14 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 14 or otherwise accessible to the processor. As such, whether configured by hardware or by a combination of hardware and software, the processor may represent an entity (e.g., physically embodied in circuitry—in the form of processing circuitry) specifically configured to perform operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

The user interface 20 may be in communication with the processing circuitry 12 to receive an indication of a user input and/or to provide an audible, visual, mechanical, or other output to a user. In one embodiment, the user interface may include, for example, a keyboard, a mouse, a joystick, a display, a touch screen display, a microphone, a speaker, and/or other input/output mechanisms. The user interface may be in communication with the memory 16 and/or communication interface 18, such as via a bus.

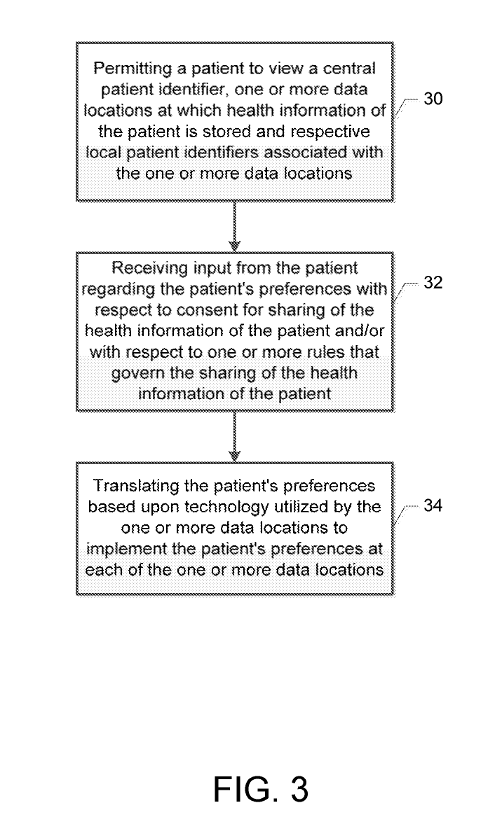

Referring now to FIG. 3, the operations performed by the computing device 10 that is in communication with the data locations that store the patient's health information, are illustrated. The computing device, such as the processing circuitry 12 and, more particularly, the processor 14, may be configured to permit the patient to view the data locations at which health information of the patient is stored as well as the patient identifiers that identify the respective patient at each of the locations. See block 30 of FIG. 3. In this regard, the computing device, such as the processing circuitry and, more particularly, the processor, may be configured to permit the patient to view a central patient identifier that universally identifies the patient for each of a plurality of data locations at which the patient's health information is stored, such as by universally identifying the patient for each of the entities serviced by a health information exchange. The computing device, such as the processing circuitry and, more particularly, the processor may also permit a patient to view one or more data locations at which the patient's health information is stored, such as by permitting the patient to view the identification or other representation of each of the data locations at which the patient's health information is stored. Further, the computing device, such as the processing circuitry and, more particularly, the processor, may be configured to permit the patient to view the respective local patient identifiers associated with the one or more data locations at which the patient's health information is stored. In this regard, the local patient identifiers identify the patient for a respective data location, but may not be recognized as identifying the patient by other data locations.

As such, the computing device 10, such as the processing circuitry 12 and, more particularly, the processor 14, causes information to be presented by the user interface 20, such as upon a display, in order to permit the patient to view the central patient identifier, the data location(s) at which the patient's health information is stored and respective local patient identifiers for those data locations. Thus, the patient may obtain a comprehensive view of the manner in which the patient's health information is stored and the identifiers associated with the patient by the respective data locations. In an instance in which consent for sharing of the patient's health information and/or one or more rules for governing the sharing of the patient's health information have been previously established, the patient may also review and audit those pre-established consent(s) and/or rule(s) for one or more of the data locations such that the patient has an understanding of the manner in which the patient's health information has previously been shared.

The patient may then provide input regarding the patient's preferences with respect to consent for sharing of the patient's health information and/or one or more rules that govern the sharing of the patient's health information. By having permitted the patient to view the various data locations at which the patient's health information is stored, the patient may provide consent and/or one or more rule that govern the sharing of the patient's health information either on a universal basis such that the same consent and/or rule(s) apply to each of the data locations or the patient may provide more individualized input with different consent and/or rule(s) being provided for different ones of the data locations. As such, the patient may tailor the manner in which the patient's health information is shared from the one or more data locations such that one data location may be authorized to share the patient's health information in a different manner than another data location, if so desired by the patient.

Thus, the computing device 10, such as the processing circuitry 12 and, more particularly, the processor 14 may be configured to receive input from the patient, such as via the user interface 20, e.g., via a keyboard, a touchscreen or the like. See block 32 of FIG. 3. The input received from the patient relates to the patient's preferences with respect to consent for sharing the health information of the patient and/or the patient's preferences with respect to one or more rules that govern the sharing of the health information of the patient. As noted above, the computing device, such as the processing circuitry and, more particularly, the processor, may be configured to receive input from the patient that provides different preferences with respect to consent and/or rule(s) that govern the sharing of the patient's health information for one data location than for other data locations. The patient's preferences with respect to consent and/or rule(s) that govern the sharing of the patient's health information may be stored by the memory 16.

The computing device 10, such as the processing circuitry 12 and, more particularly, the processor 14, may also be configured to translate the patient's preferences based upon the technology utilized by the data locations to implement the patient's preferences at each of the data locations. See block 34 of FIG. 3. In this regard, each data location may employ data privacy technology in order to appropriately control the manner in which the patient's health information is shared in accordance with the patient's preferences. For example, each data location may include a server or other data repository that is configured, such as by a privacy application executed by the server or other data repository, to share the patient's health information in accordance with the patient's preferences. A wide variety of privacy technology may be employed including, for example, proprietary Application Programming Interfaces (APIs), and policies premised upon content identifiers and/or local vocabularies, such as eXtensible Access Control Markup Language (XACML). Additionally, the translation may be performed in a variety of different manners. For example, the computing device, such as the processing circuitry, e.g., the processor, may be configured to translate the patient's preferences by mapping the patient's preferences to a common definition of preferences that may be interpreted by each of the different types of data privacy technology.

In one embodiment of the present invention, the computing device 10, such as the processing circuitry 12 and, more particularly, the processor 14, may have access to information, such as may be stored by memory 16 or may otherwise be available from the one or more data locations, that defines the technology utilized by the data locations to governs the sharing of the patient's health information or that defines the manner in which the patient's preferences are to be presented to the data location so as to be properly interpreted by the data location. Thus, the computing device, such as the processing circuitry and, more particularly, the processor, may be configured to translate the patient's preferences that are provided by the patient in accordance with the technology that will be utilized by the data locations such that the patient's preferences are able to be properly interpreted by the data locations. Since the translation is dependent upon the technology utilized by the data location to implement the patient's preferences, the computing device, such as the processing circuitry and, more particularly, the processor, may be configured to differently translate the patient's preferences for one data location and for another data location based upon the technology utilized by the respective data locations.

The computing device 10, such as the processing circuitry 12, e.g., the processor 14, the communications interface 18 or the like, may then cause the patient's preferences, following translation based upon the technology utilized by the respective data location, to be provided to the data location at which the patient's health information is stored. Each data location may, in turn, implement the patient's preferences so as to subsequently share the patient's health information in accordance with the consent and/or rule(s) defined by the patient with respect to the sharing of the patient's health information, thereby causing any pre-established consent(s) and/or rule(s) to be updated or revised in accordance with the patient's current preferences.

A method, apparatus and computer program product are therefore provided in accordance with one embodiment to permit a patient to provide their preferences with respect to the consent required for sharing of health information of the patient and the rules that would govern any sharing of the health information of the patient. As such, the patient can direct the manner in which the health information of the patient is shared. In instances in which the health information of the patient is stored in a plurality of data locations, the method, apparatus and computer program product of one embodiment may translate the patient's preferences based upon the technology employed by the various data locations, thereby effecting the patient's preferences without requiring the patient to individually define the consent required for sharing of health information of the patient and the rules that would govern any sharing of the health information of the patient for each of the various data locations

As noted above, FIG. 3 is a flowchart illustrating the operations performed by a method, apparatus and computer program product, such as computing device 10 of FIG. 2, in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 16 of a computing device employing an embodiment of the present invention and executed by a processor 14 of the computing device. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIG. 3, when executed, convert a computer or processing circuitry into a particular machine configured to perform an example embodiment of the present invention. Accordingly, the operations of FIG. 3 define an algorithm for configuring a computer or processing circuitry, e.g., processor, to perform an example embodiment. In some cases, a general purpose computer may be provided with an instance of the processor which performs the algorithm of FIG. 3 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions. In some embodiments, certain ones of the operations above may be modified or further amplified and additional optional operations may be included. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
permitting a patient to view a central patient identifier, one or more data locations at which health information of the patient is stored and respective local patient identifiers associated with the one or more data locations;
receiving input from the patient regarding the patient's preferences with respect to consent for sharing of the health information of the patient or with respect to one or more rules that govern the sharing of the health information of the patient; and
translating, with processing circuitry, the patient's preferences based upon technology utilized by the one or more data locations to implement the patient's preferences at each of the one or more data locations.

2. A method according to claim 1 wherein translating the patient's preferences comprises differently translating the patient's preferences for one data location than for another data location based upon the technology utilized by the data locations.

3. A method according to claim 2 wherein translating the patient's preferences further comprises accessing information that defines the technology utilized by the data locations.

4. A method according to claim 1 wherein the technology utilized to implement the patient's preferences comprises a privacy application utilized by a respective data location.

5. A method according to claim 1 wherein receiving input from the patient regarding the patient's preferences or with respect to one or more rules comprises receiving input from the patient that provides different preferences or different rules for one data location than for another data location.

6. A method according to claim 1 further comprising permitting a patient to review one or more pre-established consents or rules that govern the sharing of the health information of the patient by one or more data locations.

7. A method according to claim 6 further comprising revising one or more pre-established consents or rules that govern the sharing of the health information of the patient by one or more data locations based upon the input from the patient regarding the patient's preferences with respect to consent for sharing of the health information of the patient or with respect to one or more rules that govern the sharing of the health information of the patient.

8. An apparatus comprising processing circuitry configured to:
permit a patient to view a central patient identifier, one or more data locations at which health information of the patient is stored and respective local patient identifiers associated with the one or more data locations;
receive input from the patient regarding the patient's preferences with respect to consent for sharing of the health information of the patient or with respect to one or more rules that govern the sharing of the health information of the patient; and
translate the patient's preferences based upon technology utilized by the one or more data locations to implement the patient's preferences at each of the one or more data locations.

9. An apparatus according to claim 8 wherein the processing circuitry is configured to translate the patient's preferences by differently translating the patient's preferences for one data location than for another data location based upon the technology utilized by the data locations.

10. An apparatus according to claim 9 wherein the processing circuitry is configured to translate the patient's preferences by accessing information that defines the technology utilized by the data locations.

11. An apparatus according to claim 8 wherein the technology utilized to implement the patient's preferences comprises a privacy application utilized by a respective data location.

12. An apparatus according to claim 8 wherein the processing circuitry is configured to receive input from the patient regarding the patient's preferences or with respect to one or more rules by receiving input from the patient that provides different preferences or different rules for one data location than for another data location.

13. An apparatus according to claim 8 wherein the processing circuitry is further configured to permit a patient to review one or more pre-established consents or rules that govern the sharing of the health information of the patient by one or more data locations.

14. An apparatus according to claim 13 wherein the processing circuitry is further configured to revise one or more pre-established consents or rules that govern the sharing of the health information of the patient by one or more data locations based upon the input from the patient regarding the patient's preferences with respect to consent for sharing of the health information of the patient or with respect to one or more rules that govern the sharing of the health information of the patient.

15. A computer program product comprising at least one non-transitory computer-readable storage medium having computer-executable program code instructions stored therein, the computer-executable program code instructions comprising:
program code instructions configured to permit a patient to view a central patient identifier, one or more data locations at which health information of the patient is stored and respective local patient identifiers associated with the one or more data locations;
program instructions configured to receive input from the patient regarding the patient's preferences with respect to consent for sharing of the health information of the patient or with respect to one or more rules that govern the sharing of the health information of the patient; and
program instructions configured to translate the patient's preferences based upon technology utilized by the one or more data locations to implement the patient's preferences at each of the one or more data locations.

16. A computer program product according to claim 15 wherein the program code instructions configured to translate the patient's preferences comprise program code instructions configured to differently translate the patient's preferences for one data location than for another data location based upon the technology utilized by the data locations.

17. A computer program product according to claim 16 wherein the program code instructions configured to translate the patient's preferences further comprise program code instructions configured to access information that defines the technology utilized by the data locations.

18. A computer program product according to claim 15 wherein the technology utilized to implement the patient's preferences comprises a privacy application utilized by a respective data location.

19. A computer program product according to claim 15 wherein program code instructions configured to receive input from the patient regarding the patient's preferences or with respect to one or more rules comprise program code instructions configured to receive input from the patient that provides different preferences or different rules for one data location than for another data location.

20. A computer program product according to claim 15 further comprising program code instructions configured to permit a patient to review one or more pre-established consents or rules that govern the sharing of the health information of the patient by one or more data locations.
